(19) United States
(12) Patent Application Publication
(10) Pub. No.: US 2024/0298335 A1
(43) Pub. Date: Sep. 5, 2024

(54) SELECTIVE DUPLICATION FOR TIME SENSITIVE NETWORKING FLOWS

(71) Applicant: Lenovo (Singapore) Pte. Ltd., New Tech Park (SG)

(72) Inventors: Joachim Löhr, Wiesbaden (DE); Alexander Johann Maria Golitschek Edler von Elbwart, Darmstadt (DE); Ravi Kuchibhotla, Chicago, IL (US); Prateek Basu Mallick, Dreieich (DE); Karthikeyan Ganesan, Kronberg im Taunus (DE)

(21) Appl. No.: 18/263,103

(22) PCT Filed: Jan. 25, 2022
(86) PCT No.: PCT/IB2022/050647

§ 371 Date: Jul. 26, 2023

Related U.S. Application Data
(60) Provisional application No. 63/141,878, filed on Jan. 26, 2021.

(51) Int. Cl. H04W 72/232; H04L 1/00; H04L 1/1812; H04W 72/1268

(52) U.S. Cl. CPC H04W 72/232; H04L 1/0061; H04L 1/1812; H04W 72/1268

(57) ABSTRACT

Various aspects of the present disclosure relate to selective duplication for TSN flows. One apparatus includes at least one memory and at least one processor that is configured to transmit a transport block (“TB”), receive, in response to the TB, downlink control information (“DCI”), the DCI comprising a new data indicator (“NDI”) field and a control field, the NDI field comprising a value that indicates that the transmission of the TB was unsuccessful and the control field comprising a value that indicates not to perform a retransmission of the TB, and triggers at least one action to increase a transmission reliability for a subsequent TB.

### CROSS-REFERENCE TO RELATED APPLICATIONS

This application claims priority to U.S. Provisional Patent Application No. 63/141,878 entitled “SELECTIVE DUPLICATION FOR TSN FLOWS” and filed on Jan. 26, 2021, for Joachim Löhr, et al., which is incorporated herein by reference.

### FIELD

The subject matter disclosed herein relates generally to wireless communications and more particularly relates to selective duplication for time sensitive network (“TSN”) flows.

### BACKGROUND

In certain wireless communication systems, a User Equipment device (“UE”) is able to connect with a fifth-generation (“5G”) core network (i.e., “5GC”) in a Public Land Mobile Network (“PLMN”). In wireless networks, packet data convergence protocol (“PDCP”) duplication is a key feature adopted by Rel-15 to facilitate ultra-reliable low latency communication (“URLLC”) application. According to the mechanism specified for Rel-15, duplication is activated and deactivated by means of medium access control (“MAC”) control element (“CE”) signaling from a base station, e.g., gNB. However, the activation and deactivation of PDCP duplication by MAC CE signaling from the network might not be fast enough for the applications targeted within a new radio (“NR”) industrial internet of things (“IIoT”). Therefore, it has been proposed to allow the UE to autonomously enable PDCP duplication for selected packets.

### BRIEF SUMMARY

Disclosed are procedures for selective duplication for TSN flows. Said procedures may be implemented by apparatus, systems, methods, and/or computer program products.

In one embodiment, a first apparatus includes a transceiver that transmits, to a network node device, a transport block (“TB”) and receives, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the first apparatus includes a processor that enables one or more transmission reliability actions for increasing transmission reliability for subsequent TBs.

In one embodiment, a first method includes transmitting, to a network node device, a transport block (“TB”) and receiving, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the first method includes enabling one or more transmission reliability actions for increasing transmission reliability for subsequent TBs.

In one embodiment, a second apparatus includes a transceiver that receives a transport block (“TB”), from a user equipment (“UE”) device. In one embodiment, the second apparatus includes a processor that determines that at least one transmission reliability action is to be enabled for increasing reliability of transmission of TBs from the UE device. In one embodiment, the processor generates, in response to the TB, downlink control information (“DCI”) comprising a new data indicator (“NDI”) field and a control field. In one embodiment, the processor sets the NDI field to a value that indicates that transmission of the TB was not successful and the control field to a value that indicates not to perform a retransmission of the TB based on determining that at least one transmission reliability action is to be enabled. In one embodiment, the processor transmits the DCI to the UE device, the UE device enabling one or more transmission reliability actions for increasing transmission reliability for the transmission of subsequent TBs based on the values of the NDI and control fields.

In one embodiment, a second method receives a transport block (“TB”), from a user equipment (“UE”) device. In one embodiment, the second method determines that at least one transmission reliability action is to be enabled for increasing reliability of transmission of TBs from the UE device. In one embodiment, the second method generates, in response to the TB, downlink control information (“DCI”) comprising a new data indicator (“NDI”) field and a control field. In one embodiment, the second method sets the NDI field to a value that indicates that transmission of the TB was not successful and the control field to a value that indicates not to perform a retransmission of the TB based on determining that at least one transmission reliability action is to be enabled. In one embodiment, the second method transmits the DCI to the UE device, the UE device enabling one or more transmission reliability actions for increasing transmission reliability for the transmission of subsequent TBs based on the values of the NDI and control fields.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for selective duplication for TSN flows;

FIG. 2 is a procedure flow illustrating one embodiment of selective duplication for TSN flows:

FIG. 3 is one embodiment of a LogicalChannelConfig information element for selective duplication for TSN flows:

FIG. 4 is one embodiment of a ConfiguredGrantConfig for selective duplication for TSN flows:

FIG. 5 is a diagram illustrating one embodiment of a user equipment apparatus that may be used for selective duplication for TSN flows:

FIG. 6 is a diagram illustrating one embodiment of a network equipment apparatus that may be used for selective duplication for TSN flows:

FIG. 7 is a flowchart diagram illustrating one embodiment of a method for selective duplication for TSN flows; and

FIG. 8 is a flowchart diagram illustrating one embodiment of a method for selective duplication for TSN flows.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment.” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for selective duplication for TSN flows. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

PDCP duplication is a key feature adopted by Rel-15 to facilitate URLLC, which can be conducted in both downlink and uplink. The NR IIOT Study Item aims to further enhance such feature to improve both performance and efficiency of the scheme. In the objective of the Study Item on NR IIOT, the following has been approved: “Enhancements (e.g. for scheduling) to satisfy QoS for wireless Ethernet when using TSN traffic patterns as specified in TR 22.804”. The survival time is a new QoS parameter introduced by IIoT applications related to the application availability Error! Reference source not found. It can be viewed as an ultimate “rescuing” period available after a message failure before the application is declared “unavailable.”

The flow of events, in one embodiment, is as follows: the network is up and running. A source device starts sending messages to a target device, on which an automation function (e.g., an application) is running. The communication service is, from the point of view of the target application, in an up state. The up/down state of the application is based on correctly received messages. Note that the up-time interval of the application starts later than the up state of the network, e.g., with the receipt of the first message from the source device.

The network transitions into a down state if it no longer can support end-to-end transmission of the source device's messages to the target device according to the negotiated communication quality of service (“QoS”). Once the application on the target device senses the absence of expected messages, it will wait a pre-set period before it considers the communication service to be unavailable. This is the so-called survival time.

The survival time can be expressed as a period of time or, especially with cyclic traffic, as maximum number of consecutive incorrectly received or lost messages. If the survival time has been exceeded, the application transitions the status of the communication service into a down state. The application will usually take corresponding actions for handling such situations of unavailable communication services. For example, it may commence an emergency shutdown. Note that this does not imply that the target application is shut off: rather, the target application transitions into a pre-defined state, e.g., a safe state. As a general rule, the target application still “listens” to incoming packets or may try to send messages to the source application.

Once the network/communication service is in the up state again, the communication service state as perceived by the target application will change to the up state. The communication service is thus again perceived as available as soon as a message is correctly received by the application at the target device. The state of the application, however, depends on the counter measures taken by the application. The application might stay in a down state if it is in a safe state due to an emergency shutdown. Or the application may do a recovery and change to an up state again.

Since exceeding the survival time may have quite severe consequences, e.g., status of the communication service transitions to a down state, it should be the goal to ensure that transmissions of delay sensitive applications, e.g., TSN traffic flows, are correctly received within the end-to-end latency budget in order to avoid the unavailable time, e.g., down state. Therefore, the radio access network (“RAN”) needs to quickly react by increasing the reliability of the wireless link for the concerned traffic flow(s). Previously SA2 has confirmed that survival time (“ST”) will be included as a new QoS parameter in the normative specifications to support requirements of time-sensitive communication (“TSC”) applications, which is optionally provided to the RAN as a new TSC assistance information (“TSCAI”) element.

As stated in TS 22.104, “Note that the communication service reliability requirement has no direct relationship with the communication service availability requirement.” For example, referring to Table 5.1-1 of TS22.104, when the reliability requirement is 99.99%, the Communication service availability requirement can be 99.999999%, which means high availability is required even with relatively low reliability requirement of single packet. Therefore, when a service flow enters survival time, the communication system should take effort to exit survival time before survival time expiry. From the RAN perspective, the transmitter should improve the link reliability of the service flow so as to avoid another packet loss.

It is currently under discussion in RAN2 how to detect the start of survival time and how to improve the link reliability, when necessary, to avoid the expiry of the survival timer. There are several proposals which suggest supporting UE autonomous uplink reliability improvements to meet the survival time requirements. It is, for example, proposed to allow a fast reaction to transmission errors over the wireless channel by e.g., dynamically, and selectively enabling PDCP duplication. If a UE can activate UL PDCP duplication autonomously according to some predefined criteria, the latency and reliability requirements of subsequent packets can be guaranteed. Some suggestions include the UE enabling PDCP duplication (for the next MAC packet data unit (“PDU”)) in case UE receives a retransmission UL downlink control information (“DCI”) (e.g., with new data indicator (“NDI”) non-toggled) for the previous packet. It might be, however, possible that the delay requirements are so tight for a TSN service that there is actually no time for a hybrid automatic repeat request (“HARQ”) retransmission. Nevertheless, the UE may enable PDCP duplication or increase the reliability of the next packet if a previous packet was not successfully received (e.g., lost). According to current DCI, there is no possibility to indicate to the UE (within a UL DCI) that the packet was not successfully received (e.g., a negative acknowledgement (“NACK”)) but the UE shall not perform a retransmission.

PDCP duplication is a key feature adopted by Rel-15 to facilitate URLLC application. According to the mechanism specified for Rel-15, duplication is activated/deactivated by means of MAC CE signaling from the gNB. However, the activation/deactivation of PDCP duplication by MAC CE signaling from the network might not be fast enough for the applications targeted within the NR IIOT Study Item. Therefore, it has been proposed to allow the UE to autonomously enable PDCP duplication for selected packets.

To avoid consecutive transmission failures and the expiry of the survival timer, the transmitter needs to take appropriate measures, e.g., increasing reliability by enabling PDCP duplication upon the indication of a transmission (“Tx”) error. It has been proposed that the UE enables PDCP duplication in response to receiving a retransmission grant, e.g., UL DCI with NDI set to ‘1’. Though, it is possible that delay requirements are so tight for a TSN service that HARQ retransmissions are not supported. Nevertheless, the UE shall enable PDCP duplication if a previous packet was not successfully received. NR DCI formats do not indicate that a physical uplink shared channel (“PUSCH”) Tx was not successful without requesting a retransmission.

As described herein, a new field in a DCI indicates whether the UE shall perform a UL HARQ retransmission for cases when the PUSCH transmission was not successfully decoded. In response to receiving a DCI indicating that the previous PUSCH transmission, e.g., on a configured uplink grant, was not successful, e.g., NDI set to 1, and that no HARQ retransmission shall be performed, UE considers the packet as lost and enables PDCP duplication.

According to a first embodiment, a DCI indicates whether an UL HARQ retransmission should be performed by a transmitter for a previous PUSCH transmission that was not correctly decoded by the receiver. The NDI field in the DCI is set to the same value compared to the value of the DCI for the previous PUSCH transmission corresponding to this transport block (“TB”), e.g., NDI is set to 1, indicating that the previous transmission of the TB was not successful, e.g., a NACK. A new field in the DCI indicates whether the UE shall perform a HARQ retransmission or not.

According to second embodiment, the network configures whether HARQ retransmissions are supported for a configured grant configuration. The ConfiguredGrantConfig information element (“IE”) contains a field specifying whether HARQ retransmission are supported for the corresponding uplink configured grant configuration. When the UE receives a DCI requesting a HARQ retransmission for a TB which was initially transmitted on a CG for which HARQ retransmissions are not supported, the UE skips the allocated PUSCH transmission and enables PDCP duplication.

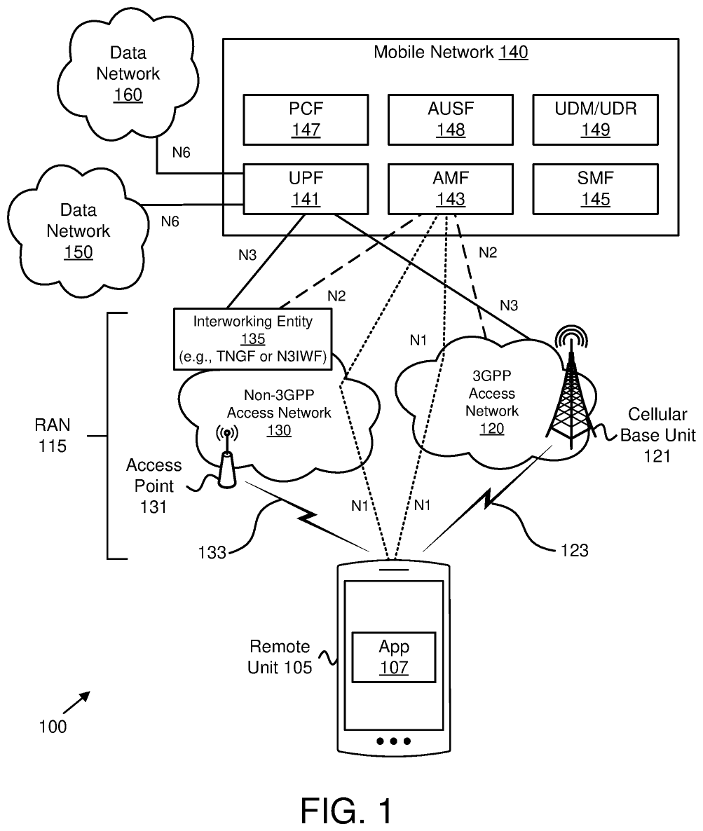

FIG. 1 depicts a wireless communication system 100 for selective duplication for TSN flows, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

In the following the term eNB/gNB is used for the base station but it is replaceable by any other radio access node, e.g., BS, eNB, gNB, AP, NR, or the like. Further, the proposed solutions are described mainly in the context of 5G NR. However, the proposed solutions may also be applicable to other mobile communication systems supporting services targeted by the Study Item on NR IIoT.

To avoid consecutive transmission failures, in one embodiment, the transmitter identifies when it should enter the survival time state and take appropriate measures, e.g., increasing reliability by enabling PDCP duplication or enabling PUSCH repetitions or other methods that increase the reliability of a packet, to prevent survival timer expiration. The criteria or conditions for the transmitter to consider entering the survival time state include, according to one embodiment, an explicit indication from the gNB that a packet was not correctly received, e.g., a NACK or a retransmission grant received at a MAC layer in response to an uplink packet transmission on PUSCH, e.g., the transmitter enters the survival time state and increases the reliability of later messages, for example, by enabling PDCP duplication or increasing the transmission power for the subsequent packet(s).

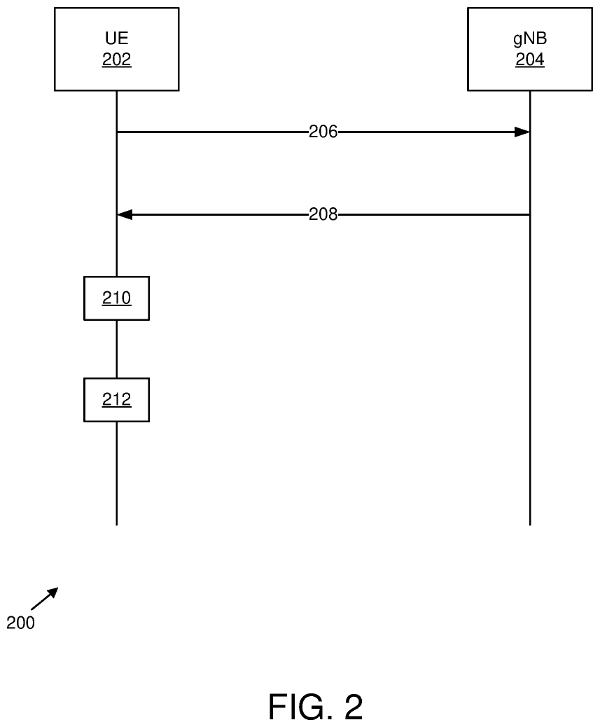

FIG. 2 depicts a procedure 200 for selective duplication for TSN flows. In a first embodiment, shown in FIG. 2, downlink control signaling indicates whether a retransmission should be performed by a transmitter, e.g., a UE 202, for a previous TB PUSCH transmission that was not correctly decoded by the receiver, e.g., a gNB 204. In one implementation of this embodiment the downlink control signaling is a DCI, e.g., DCI format 0_1.

In one embodiment, the UE 202 transmits (see messaging 206) a TB to a gNB 204 (or other base station/network node). The gNB 204 transmits (see messaging 208) DCI to the UE 202. In an embodiment, the NDI field in the DCI with CRC scrambled with C-RNTI is set to the same value compared to the value of the DCI for the previous transmission corresponding to this TB, e.g., NDI is not toggled, indicating that the previous transmission of the TB was not successful, e.g., a NACK, or, in one example, NDI is set to 1 for the case that DCI with cyclic redundancy check (“CRC”) scrambled with configured scheduling radio network temporary identifier (“CS-RNTI”) is used.

In one embodiment, the UE 202 determines (see block 210) whether to retransmit the TB or not based on the DCI. In an embodiment, a new field in the DCI, e.g., a control field, indicates whether the transmitter, e.g., the UE shall perform a retransmission of the corresponding TB. In an embodiment, a control field that is set to ‘1’ indicates that the transmitter, e.g., UE 202, shall perform a retransmission of the TB according to other fields signaled within the DCI such as, e.g., time domain resource assignment, redundancy version, frequency domain resource assignment, and/or the like.

In an embodiment, a control field that is set to ‘0’ indicates that the transmitter, e.g., UE 202, shall not perform a retransmission of the TB and shall ignore other fields within the DCI indicating information for a PUSCH (re)transmission, e.g., time domain resource assignment, redundancy version, frequency domain resource assignment, and/or the like. This may be considered a packet loss indication.

In an embodiment, a combination of existing fields within the DCI that are set to a specific value indicates that the transmitter, e.g., UE 202, shall not perform a retransmission of the corresponding TB even though the TB was not received successfully. For example, if the transport block size (“TBS”), as indicated by fields of the DCI, does not match the TBS of the previous transmission of the corresponding TB, the UE shall not perform a retransmission of the TB, e.g., skip the allocated PUSCH transmission. In an embodiment, a reserved codepoint of an existing field in a DCI (with non-toggled NDI) indicates that the transmitter shall not perform a HARQ retransmission.

In one embodiment, the transmitter, e.g., UE 202, enables (see block 212) PDCP duplication or increases the transmission reliability by, e.g., increasing transmission power or adapting L1/L2 configuration/transmission parameters in response to receiving a DCI indicating that the previous PUSCH transmission was not successfully received by the gNB 204, e.g., by a non-toggled NDI or NDI set to ‘I’ for physical downlink control channel (“PDCCH”) addressed to CS-RNTI, and the DCI further indicates that the transmitter shall not perform a retransmission of the corresponding TB, e.g., NACK-only. In one embodiment, the DCI is a UL DCI with CRC scrambled by cell RNTI (“C-RNTI”) or CS-RNTI.

In a second embodiment, the UE does not perform a HARQ retransmission of a TB in response to receiving an UL DCI for scheduling uplink resources for a HARQ retransmission (indicating a NACK) if the corresponding HARQ retransmission on PUSCH would occur after the maximum allowed transmission time associated with this TB.

According to one implementation of this embodiment, the UE ignores the UL DCI received from gNB. In one implementation, the UE increases the transmission reliability for subsequent packet transmission(s), e.g., by enabling PDCP duplication or applying some other techniques such as increasing transmission power or adapting L1/L2 configuration/transmission parameters, in response to the reception of such UL DCI, e.g., UL DCI scheduling a retransmission (non-toggled NDI) on PUSCH, which occurs after the maximum allowed transmission time associated with this TB. The maximum allowed transmission time is in one example the packet delay budget (“PDB”). The PDB, in one embodiment, denotes the upper bound for the delay of the data packets transferred by a data bearer. 3GPP specifications, in one embodiment, establish PDB as the primary goal of the scheduling framework.

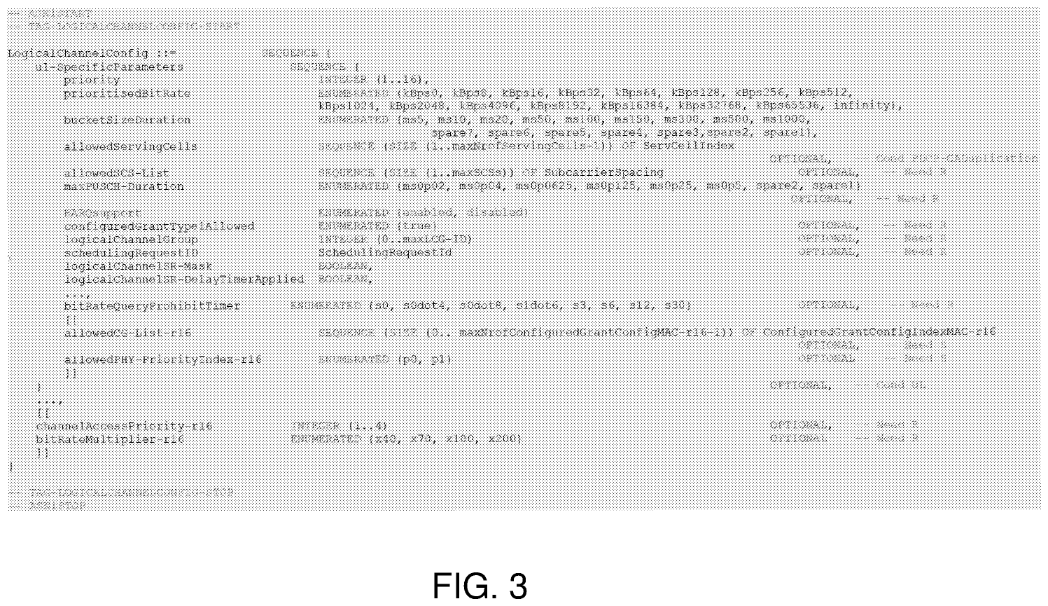

In a third embodiment, a logical channel is configured with a parameter configuring whether HARQ retransmission(s) should be enabled or whether only a one-time transmission is to be applied for data of the corresponding logical channel. Such configuration may be, in one example, carried out by radio resource control (“RRC”) signaling. In one example, a new field “HARQsupport” is added to the LogicalChannelConfig IE, shown in FIG. 3, indicating whether HARQ retransmission are supported or not.

In one embodiment, for cases when the UE receives an UL DCI indicating uplink resources for a HARQ retransmission (e.g., non-toggled NDI for DCI addressed to C-RNTI or NDI set to ‘1’ for DCI addressed to CS-RNTI) of a TB that contains data of logical channel(s) that do not support HARQ retransmissions, the UE ignores the UL DCI, e.g., the UE does not perform the PUSCH transmission, and considers the UL DCI as a trigger to increase the transmission reliability for subsequent packet transmission(s), e.g., by enabling PDCP duplication for all logical channels (“LCHs”) from which data is included in the corresponding TB for which the HARQ feedback is received.

According to one embodiment, the UE determines, during a logical channel prioritization (“LCP”) procedure, whether HARQ retransmission are supported or not for a configuration of an LCH, e.g., by a parameter or field “HARQsupport.” as an input for the logical channel restriction procedure. According to one implementation, only LCHs are considered during the LCP procedure, e.g., for generating a TB, having the same configuration with respect to HARQ retransmission support.

In one example, only LCHs that support HARQ retransmissions are allowed to be multiplexed in one TB or MAC PDU. According to one implementation of the embodiment, the highest priority logical channel among the logical channels that are multiplexed or have data available that can be multiplexed determines whether HARQ retransmissions are supported or not for the MAC PDU, e.g., in case the highest priority logical channel is configured for HARQ retransmissions, only LCHs that also support HARQ retransmissions are allowed to be multiplexed within the corresponding MAC PDU, e.g., the LCP considers only LCHs that support HARQ retransmissions.

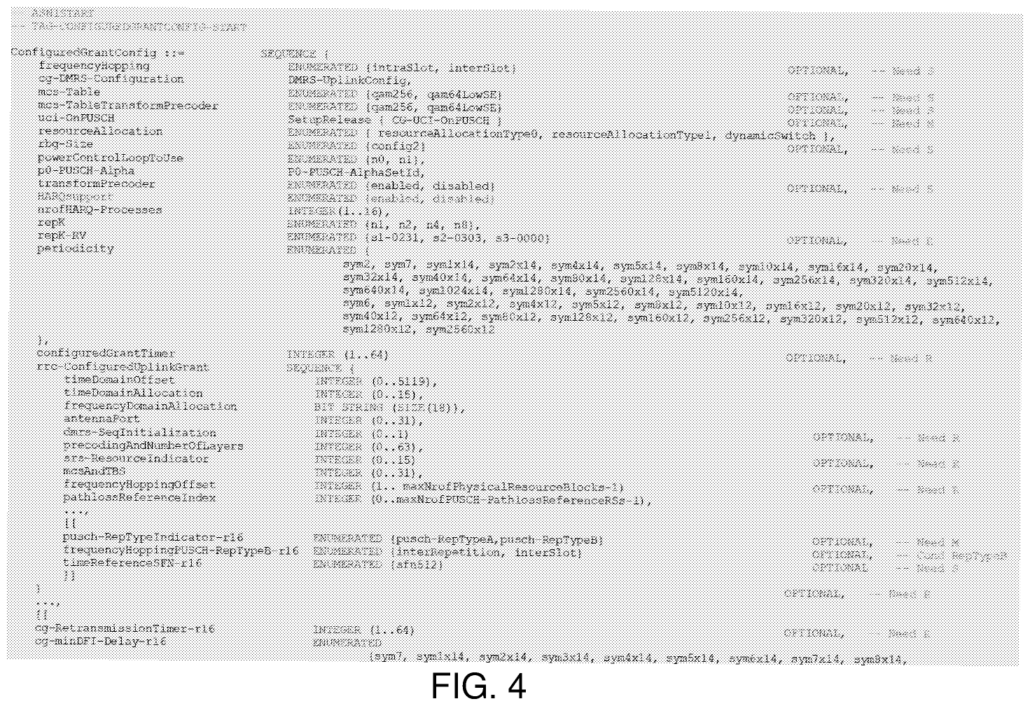

In a fourth embodiment, the network configures whether HARQ retransmissions are supported for a configured grant configuration. In one example, the ConfiguredGrantConfig 1E, shown in FIG. 4, contains a field specifying whether HARQ retransmission are supported for the corresponding uplink configured grant configuration. For cases where the UE receives a DCI requesting a HARQ retransmission for a TB that was initially transmitted on a configured uplink grant (e.g., DCI with CRC scrambled by CS-RNTI) for which HARQ retransmissions are not supported, the UE does not perform the PUSCH (re)transmission on the allocated uplink resources.

According to one implementation of this embodiment, the UE considers the reception of such a DCI (requesting a HARQ retransmission even though HARQ retransmissions are disabled for the corresponding CG configuration) as an indication that the TB was not successfully received and further as a trigger to increase the transmission reliability for subsequent transmission(s) on the configured grant, e.g., enabling PDCP duplication.

In a fifth embodiment, the UE considers the transmission of a TB as unsuccessful in response to not receiving feedback from the gNB within a predefined time period. In one embodiment, the UE considers a PUSCH transmission of a TB on a configured uplink grant as not successfully received by the gNB when no feedback is received before the transmission of a TB on a subsequent configured uplink grant.

In one embodiment, the UE starts a timer upon having performed a PUSCH transmission on a (configured) uplink grant. Upon expiry of this timer, in one embodiment, the UE considers the transmission of the TB on the configured uplink grant as unsuccessful. The timer may be a new timer or an existing timer such as cg-RetransmissionTimer or configuredGrantTimer. In one embodiment, the UE enables PDCP duplication or increases the transmission reliability by another mechanism, such as increasing transmission power, enabling PUSCH repetition, and/or the like, upon expiry of the timer. In one embodiment, the feedback may be a DCI indicating the successful reception of the PUSCH transmission. In one embodiment, the feedback may be a DFI signaling within a DCI. Upon reception of a DCI indicating the successful reception of the TB transmitted on the configured uplink grant, in one embodiment, the UE stops the timer.

According to one further implementation of the above embodiments, the UE selectively enables PDCP duplication or increases the transmission reliability by, e.g., increasing transmission power or adapting L1/L2 configuration/transmission parameters in response to, e.g., receiving a DCI indicating that the previous PUSCH transmission was not successfully received by the gNB for some predefined time period. In one embodiment, the UE enables PDCP duplication on a per-packet basis, e.g., duplicate transmission is only effective for the transmission of one PDCP PDU.

According to another embodiment, with duplication enabled, upon reception of a packet transmission error/loss indication, the UE performs duplicate transmissions not only for the next PDCP PDU but also for the transmission(s) of subsequent PDCP PDUs according to some predefined condition. In one embodiment, the UE continues to perform duplication for the next N (N being a predefined or network configured value) packets or PDCP PDUs.

In another embodiment, the UE is configured with a timer that is started when PDCP duplication is enabled, e.g., upon reception of an indication that a packet was not transmitted successfully. In such an embodiment, the UE continues to transmit duplicates until the expiry of the timer. The timer value may be predefined or preconfigured by the network.

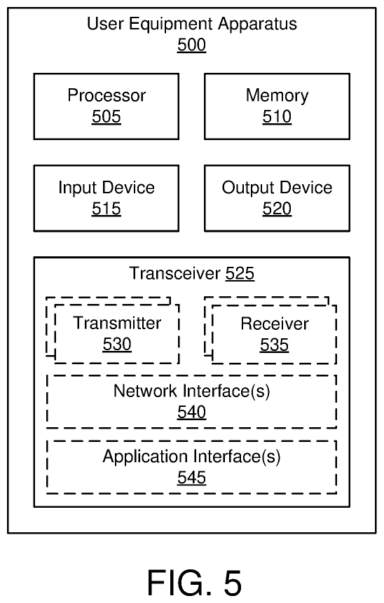

FIG. 5 depicts a user equipment apparatus 500 that may be used for selective duplication for TSN flows, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panel supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 and/or transceiver 525 controls the user equipment apparatus 500 to implement the above-described UE behaviors. In one embodiment, the transceiver 525 transmits, to a network node device, a transport block (“TB”) and receives, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the processor 505 enables one or more transmission reliability actions for increasing transmission reliability for subsequent TBs.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, hybrid automatic repeat request (“HARQ”) retransmission of the TB is not initiated in response to a reserved codepoint of an existing field in the DCI indicating that a retransmission of the TB is not to be performed.

In one embodiment, the processor 505 initiates hybrid automatic repeat request (“HARQ”) retransmission of the TB in response to setting the NDI field to a value that indicates that transmission of the TB was not successful and the control field to a value that indicates retransmission of the TB, without enabling the one or more transmission reliability actions.

In one embodiment, HARQ retransmission of the TB is not initiated in response to HARQ retransmission of the TB taking place after the maximum allowed transmission time associated with this TB.

In one embodiment, HARQ retransmission is initiated according to one or more other fields signaled within the DCI, the one or more other fields comprising at least one selected from the group of: a time domain resource assignment, a redundancy version, and a frequency domain resource assignment.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to selective duplication for TSN flows. For example, the memory 510 may store various parameters, panel/beam configurations, resource assignments, policies, and the like as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

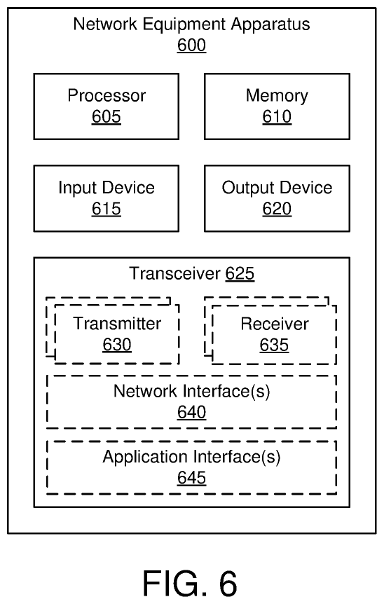

FIG. 6 depicts a network apparatus 600 that may be used for selective duplication for TSN flows, according to embodiments of the disclosure. In one embodiment, network apparatus 600 may be one implementation of a RAN node, such as the base unit 121, the RAN node 210, or gNB, described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 805 may include an application processor (also known as “main processor”) which manages application-domain and operating system (“OS”) functions and a baseband processor (also known as “baseband radio processor”) which manages radio function.

In various embodiments, the processor 605 and/or transceiver 625 controls the network apparatus 600 to implement the above-described network apparatus behaviors. In one embodiment, the transceiver 625 receives a transport block (“TB”), from a user equipment (“UE”) device. In one embodiment, the processor 605 determines that at least one transmission reliability action is to be enabled for increasing reliability of transmission of TBs from the UE device. In one embodiment, the processor 605 generates, in response to the TB, downlink control information (“DCI”) comprising a new data indicator (“NDI”) field and a control field. In one embodiment, the processor 605 sets the NDI field to a value that indicates that transmission of the TB was not successful and the control field to a value that indicates not to perform a retransmission of the TB based on determining that at least one transmission reliability action is to be enabled. In one embodiment, the processor 605 transmits the DCI to the UE device, the UE device enabling one or more transmission reliability actions for increasing transmission reliability for the transmission of subsequent TBs based on the values of the NDI and control fields.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, the processor 605 initiates HARQ retransmission of the TB in response to setting the NDI field to a value that indicates that transmission of the TB was not successful and the control field to a value that indicates retransmission of the TB, without enabling the one or more transmission reliability actions.

In one embodiment, the processor 605 initiates hybrid automatic repeat request (“HARQ”) retransmission of the TB in response to setting a reserved codepoint of an existing field in the DCI to a value that indicates that a retransmission of the TB is not to be performed.

In various embodiments, the network apparatus 600 is a RAN node (e.g., gNB) that includes a transceiver 625 that sends, to a user equipment (“UE”) device, an indication that channel state information (“CSI”) corresponding to multiple transmit/receives points (“TRPs”) is to be reported and receives at least one CSI report from the UE corresponding to one or more of the multiple TRPs, the CSI report generated according to the CSI reporting configuration, the at least one CSI report comprising a CSI-reference signal (“CSI-RS”) resource indicator (“CRI”).

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to selective duplication for TSN flows. For example, the memory 610 may store parameters, configurations, resource assignments, policies, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the NPN, PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

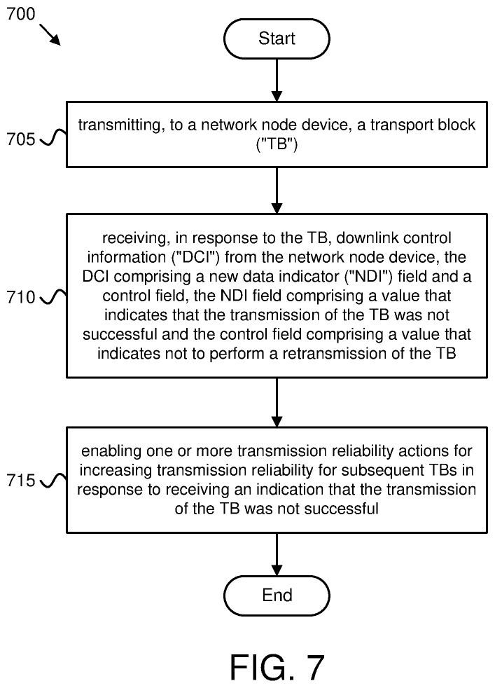

FIG. 7 is a flowchart diagram of a method 700 for selective duplication for TSN flows. The method 700 may be performed by a UE as described herein, for example, the remote unit 105, the UE 205 and/or the user equipment apparatus 500. In some embodiments, the method 700 may be performed by a processor executing program code, for example, a microcontroller, a microprocessor, a CPU, a GPU, an auxiliary processing unit, a FPGA, or the like.

The method 700, in one embodiment, includes transmitting 705, to a network node device, a transport block (“TB”). In one embodiment, the method 700 includes receiving 710, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the method 700 includes enabling 715 one or more transmission reliability actions for increasing transmission reliability for subsequent TBs in response to receiving an indication that the transmission of the TB was not successful. The method 700 ends.

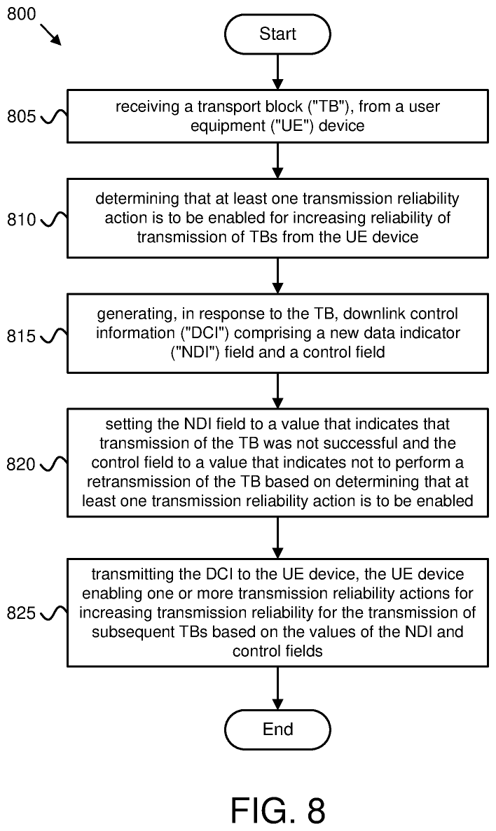

FIG. 8 is a flowchart diagram of a method 800 for selective duplication for TSN flows. The method 800 may be performed by a network device described herein, for example, a gNB, a base station, and/or the network equipment apparatus 600. In some embodiments, the method 800 may be performed by a processor executing program code, for example, a microcontroller, a microprocessor, a CPU, a GPU, an auxiliary processing unit, a FPGA, or the like.

In one embodiment, the method 800 includes receiving 805 a transport block (“TB”), from a user equipment (“UE”) device. In one embodiment, the method 800 includes determining 810 that at least one transmission reliability action is to be enabled for increasing reliability of transmission of TBs from the UE device. In one embodiment, the method 800 includes generating 815, in response to the TB, downlink control information (“DCI”) comprising a new data indicator (“NDI”) field and a control field. In one embodiment, the method 800 includes setting 820 the NDI field to a value that indicates that transmission of the TB was not successful and the control field to a value that indicates not to perform a retransmission of the TB based on determining that at least one transmission reliability action is to be enabled. In one embodiment, the method 800 includes transmitting 825 the DCI to the UE device, the UE device enabling one or more transmission reliability actions for increasing transmission reliability for the transmission of subsequent TBs based on the values of the NDI and control fields. The method 800 ends.

A first apparatus is disclosed for selective duplication for TSN flows. The first apparatus may be embodied as a UE as described herein, for example, the remote unit 105, the UE 205 and/or the user equipment apparatus 500. In some embodiments, the first apparatus may include a processor executing program code, for example, a microcontroller, a microprocessor, a CPU, a GPU, an auxiliary processing unit, a FPGA, or the like.

In one embodiment, a first apparatus includes a transceiver that transmits, to a network node device, a transport block (“TB”) and receives, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the first apparatus includes a processor that enables one or more transmission reliability actions for increasing transmission reliability for subsequent TBs.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, hybrid automatic repeat request (“HARQ”) retransmission of the TB is not initiated in response to a reserved codepoint of an existing field in the DCI indicating that a retransmission of the TB is not to be performed.

In one embodiment, the processor initiates hybrid automatic repeat request (“HARQ”) retransmission of the TB in response to setting the NDI field to a value that indicates that transmission of the TB was not successful and the control field to a value that indicates retransmission of the TB, without enabling the one or more transmission reliability actions.

In one embodiment, HARQ retransmission of the TB is not initiated in response to HARQ retransmission of the TB taking place after the maximum allowed transmission time associated with this TB.

In one embodiment, HARQ retransmission is initiated according to one or more other fields signaled within the DCI, the one or more other fields comprising at least one selected from the group of: a time domain resource assignment, a redundancy version, and a frequency domain resource assignment.

A first method is disclosed for selective duplication for TSN flows. The first method may be performed by a UE as described herein, for example, the remote unit 105, the UE 205 and/or the user equipment apparatus 500. In some embodiments, the first method may be performed by a processor executing program code, for example, a microcontroller, a microprocessor, a CPU, a GPU, an auxiliary processing unit, a FPGA, or the like.

In one embodiment, a first method includes transmitting, to a network node device, a transport block (“TB”) and receiving, in response to the TB, downlink control information (“DCI”) from the network node device, the DCI comprising a new data indicator (“NDI”) field and a control field, the NDI field comprising a value that indicates that the transmission of the TB was not successful and the control field comprising a value that indicates not to perform a retransmission of the TB. In one embodiment, the first method includes enabling one or more transmission reliability actions for increasing transmission reliability for subsequent TBs.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, hybrid automatic repeat request (“HARQ”) retransmission of the TB is not initiated in response to a reserved codepoint of an existing field in the DCI indicating that a retransmission of the TB is not to be performed.

In one embodiment, the first method includes initiating hybrid automatic repeat request (“HARQ”) retransmission of the TB in response to setting the NDI field to a value that indicates that transmission of the TB was not successful and the control field to a value that indicates retransmission of the TB, without enabling the one or more transmission reliability actions.

In one embodiment, HARQ retransmission of the TB is not initiated in response to HARQ retransmission of the TB taking place after the maximum allowed transmission time associated with this TB.

In one embodiment, HARQ retransmission is initiated according to one or more other fields signaled within the DCI, the one or more other fields comprising at least one selected from the group of: a time domain resource assignment, a redundancy version, and a frequency domain resource assignment.

A second apparatus is disclosed for selective duplication for TSN flows. The second apparatus may be embodied as a network device described herein, for example, a gNB, a base station, and/or the network equipment apparatus 600. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver that receives a transport block (“TB”), from a user equipment (“UE”) device. In one embodiment, the second apparatus includes a processor that determines that at least one transmission reliability action is to be enabled for increasing reliability of transmission of TBs from the UE device. In one embodiment, the processor generates, in response to the TB, downlink control information (“DCI”) comprising a new data indicator (“NDI”) field and a control field. In one embodiment, the processor sets the NDI field to a value that indicates that transmission of the TB was not successful and the control field to a value that indicates not to perform a retransmission of the TB based on determining that at least one transmission reliability action is to be enabled. In one embodiment, the processor transmits the DCI to the UE device, the UE device enabling one or more transmission reliability actions for increasing transmission reliability for the transmission of subsequent TBs based on the values of the NDI and control fields.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, the processor initiates HARQ retransmission of the TB in response to setting the NDI field to a value that indicates that transmission of the TB was not successful and the control field to a value that indicates retransmission of the TB, without enabling the one or more transmission reliability actions.

In one embodiment, the processor initiates hybrid automatic repeat request (“HARQ”) retransmission of the TB in response to setting a reserved codepoint of an existing field in the DCI to a value that indicates that a retransmission of the TB is not to be performed.

A second method is disclosed for selective duplication for TSN flows. The second method may be performed by a network device described herein, for example, a gNB, a base station, and/or the network equipment apparatus 600. In some embodiments, the second method may be performed by a processor executing program code, for example, a microcontroller, a microprocessor, a CPU, a GPU, an auxiliary processing unit, a FPGA, or the like.

In one embodiment, the second method receives a transport block (“TB”), from a user equipment (“UE”) device. In one embodiment, the second method determines that at least one transmission reliability action is to be enabled for increasing reliability of transmission of TBs from the UE device. In one embodiment, the second method generates, in response to the TB, downlink control information (“DCI”) comprising a new data indicator (“NDI”) field and a control field. In one embodiment, the second method sets the NDI field to a value that indicates that transmission of the TB was not successful and the control field to a value that indicates not to perform a retransmission of the TB based on determining that at least one transmission reliability action is to be enabled. In one embodiment, the second method transmits the DCI to the UE device, the UE device enabling one or more transmission reliability actions for increasing transmission reliability for the transmission of subsequent TBs based on the values of the NDI and control fields.

In one embodiment, the one or more transmission reliability actions comprises enabling packet data convergence protocol (“PDCP”) duplication. In one embodiment, the one or more transmission reliability actions comprises increasing transmission power.

In one embodiment, the DCI is an uplink DCI with cyclic redundancy check (“CRC”) scrambled by one of cell radio network temporary identifier (“C-RNTI”) and configured scheduling RNTI (“CS-RNTI”).

In one embodiment, the second method initiates HARQ retransmission of the TB in response to setting the NDI field to a value that indicates that transmission of the TB was not successful and the control field to a value that indicates retransmission of the TB, without enabling the one or more transmission reliability actions.

In one embodiment, the second method initiates hybrid automatic repeat request (“HARQ”) retransmission of the TB in response to setting a reserved codepoint of an existing field in the DCI to a value that indicates that a retransmission of the TB is not to be performed.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) device apparatus for wireless communication, the apparatus comprising:
at least one memory; and
at least one processor coupled with the at least one memory and configured to cause the UE to:
transmits, to a network node device, a transport block (“TB”); receive, in response to the TB, downlink control information (“DCI”), the DCI comprising a new data indicator (“NDI”) field and a control field, the NDI field comprising a value that indicates that the transmission of the TB was unsuccessful and the control field comprising a value that indicates not to perform a retransmission of the TB; and
trigger at least one action to increase a transmission reliability for a subsequent TB.

2. The UE of claim 1, wherein the at least one action comprises performing packet data convergence protocol (“PDCP”) duplication.

3. The UE of claim 1, wherein the at least one action comprises increasing a transmission power level.

4. The UE of claim 1, wherein the DCI comprises a cyclic redundancy check (“CRC”) scrambled by a cell radio network temporary identifier (“C-RNTI”) or a configured scheduling RNTI (“CS-RNTI”).

5. The UE of claim 1, wherein hybrid automatic repeat request (“HARQ”) retransmission of the TB is not initiated in response to a reserved codepoint in the DCI indicating that the retransmission of the TB is not to be performed.

6. The UE of claim 1, wherein the at least one processor is configured to cause the UE to initiate hybrid automatic repeat request (“HARQ”) retransmission of the TB in response to setting the NDI field to the value that indicates that the transmission of the TB was unsuccessful and the control field to the value that indicates retransmission of the TB, without enabling the at least one action.

7. The UE of claim 6, wherein the HARQ retransmission of the TB is not initiated in response to the HARQ retransmission of the TB taking place occurring after the maximum allowed transmission time associated with the TB.

8. The UE of claim 6, wherein the HARQ retransmission is initiated according to one or more other fields within the DCI, the one or more other fields comprising at least one selected from the group of: a time domain resource assignment, a redundancy version, and a frequency domain resource assignment.

9. A network equipment for wireless communication, comprising:
at least one memory; and
at least one processor coupled with the at least one memory and configured to cause the network equipment to:
receive a transport block (“TB”);
determine that at least one transmission reliability action is to be enabled for increasing reliability of transmission of TBs;
generate, in response to the TB, downlink control information (“DCI”) comprising a new data indicator (“NDI”) field and a control field;
set the NDI field to a value that indicates that transmission of the TB was not successful and the control field to a value that indicates not to perform a retransmission of the TB based on determining that at least one transmission reliability action is to be enabled; and
transmit the DCI for triggering at least one actions to increase transmission reliability for the transmission of subsequent TBs based on the values of the NDI and control fields.

10. The network equipment of claim 9, wherein the at least one action comprises performing packet data convergence protocol (“PDCP”) duplication.

11. The network equipment of claim 9, wherein the at least one action comprises increasing a transmission power level.

12. The network equipment of claim 9, wherein the DCI comprises a cyclic redundancy check (“CRC”) scrambled by one of a cell radio network temporary identifier (“C-RNTI”) or a configured scheduling RNTI (“CS-RNTI”).

13. The network equipment of claim 9, wherein the at least one processor is configured to cause the network equipment to initiate HARQ hybrid automatic repeat request (“HARQ”) retransmission of the TB in response to setting the NDI field to the value that indicates that the transmission of the TB was unsuccessful and the control field to the value that indicates retransmission of the TB, without enabling the at least one action.

14. The network equipment of claim 9, wherein the at least one processor is configured to cause the network equipment to initiate hybrid automatic repeat request (“HARQ”) retransmission of the TB in response to setting a reserved codepoint in the DCI to a value that indicates that the retransmission of the TB is not to be performed.

15. A method performed by a user equipment (“UE”) device, the method comprising:
transmitting, a transport block (“TB”);
receiving, in response to the TB, downlink control information (“DCI”) from the network node device, the DCI comprising a new data indicator (“NDI”) field and a control field, the NDI field comprising a value that indicates that the transmission of the TB was unsuccessful and the control field comprising a value that indicates not to perform a retransmission of the TB; and
triggering at least one action to increase a transmission reliability for a subsequent TB.

16. A processor for wireless communication, comprising:
at least one controller coupled with at least one memory and configured to cause the processor to:
transmit a transport block (“TB”);
receive, in response to the TB, downlink control information (“DCI”), the DCI comprising a new data indicator (“NDI”) field and a control field, the NDI field comprising a value that indicates that the transmission of the TB was not successful and the control field comprising a value that indicates not to perform a retransmission of the TB; and
trigger at least one action to increase a transmission reliability for a subsequent TB.

17. The processor of claim 16, wherein the at least one action comprises performing packet data convergence protocol (“PDCP”) duplication.

18. The processor of claim 16, wherein the at least one action comprises increasing a transmission power level.

19. The processor of claim 16, wherein the DCI comprises a cyclic redundancy check (“CRC”) scrambled by a cell radio network temporary identifier (“C-RNTI”) or a configured scheduling RNTI (“CS-RNTI”).

20. The processor of claim 16, wherein hybrid automatic repeat request (“HARQ”) retransmission of the TB is not initiated in response to a reserved codepoint in the DCI indicating that the retransmission of the TB is not to be performed.
